(19) United States
(12) Patent Application Publication
(10) Pub. No.: US 2020/0261980 A1
(43) Pub. Date: Aug. 20, 2020

(54) METHOD FOR IDENTIFYING AND FORMING VIABLE HIGH ENTROPY ALLOYS VIA ADDITIVE MANUFACTURING

(71) Applicant: Hamilton Sundstrand Corporation, Charlotte, NC (US)

(72) Inventors: Sergey Mironets, Szymanow OT (PL); Thomas J. Martin, East Hampton, CT (US); Alexander Staroselsky, Avon, CT (US)

(21) Appl. No.: 16/280,990

(22) Filed: Feb. 20, 2019

(51) Int. Cl. B22F 3/23; B22F 3/15; B33Y 10/00; B33Y 70/00

(52) U.S. Cl. CPC B22F 3/23; B22F 3/15; B22F 2301/20; B33Y 70/00; B33Y 10/00

(57) ABSTRACT

An example embodiment of a method is disclosed for making a component including a high entropy alloy (HEA). The method includes combining a reaction component with a powdered HEA precursor to form a solid HEA feedstock. The solid HEA feedstock is converted into a powder suitable for use as a powder feedstock in an additive manufacturing device and capable of sustaining a self-propagating high-temperature synthesis (SHS) reaction. At least a portion of the powder feedstock is additively manufactured into a preformed shape approximating a desired shape of the component. The preformed shape is filled with the HEA powder feedstock. The powdered HEA precursor in the preformed shape are ignited to induce the self-propagating high-temperature synthesis (SHS) reaction, thereby forming a stable HEA component approximating the desired shape.

### BACKGROUND

The disclosure relates generally to high entropy alloys (HEA) and more specifically to processes for identifying viable high entropy alloys and forming them into useful components by way of additive manufacturing.

Many advanced high temperature alloys, due to thermodynamic or other limitations, often consist of one or two primary components (e.g., nickel-based superalloys, titanium aluminide, etc.) with small amounts (e.g., no more than about 15% and often less) of multiple alloying elements to tailor particular mechanical, thermal, and/or microstructural properties). In contrast, high entropy alloys have a larger number (e.g., 4 or more) of constituents in roughly equal percentages. For most combinations, this causes microstructural instability for reasons that should be apparent to a skilled artisan familiar with materials science or other related fields.

At the same time, certain narrow combinations of elements have been identified which would fall within the range of an HEA, but exhibit a higher level of stability as well as excellent properties exceeding those seen in conventional superalloys. Yet those alloys have to date been infeasible to produce into useful components due to the inability to post-process without locally disturbing the narrowly stable microstructure.

Previous methods known to produce partially stable HEA structures have taken two forms. The first involves providing a preform, adding the molten alloy which is then solidified and subjected to hot isostatic processing (HIP). Despite this, the microstructure is inconsistent and porosity remains an impediment to a useful, stable part. Another known approach with its own shortcomings involves a preform then forging the finished part. Like the first, the issues of severe porosity and inconsistent microstructure remain. Both of these manufacturing processes are not yet able to produce complex shaped parts.

Roughly 70% of High Entropy Alloys (HEA) microstructure studies characterize as-cast alloys. The vast majority of the HEAs development approaches are based on ad-hoc alloy design rules, which require corroboration by experiments. The experiments are limited by solubility of alloying elements for producing homogenous materials without macro segregation. There is a need for developing an economical process for development of new generation of HEA.

### SUMMARY

An example embodiment of a method is disclosed for making a component including a high entropy alloy (HEA). The method includes combining a reaction component with a powdered HEA precursor to form a solid HEA feedstock. The solid HEA feedstock is converted into a powder suitable for use as a powder feedstock in an additive manufacturing device and capable of sustaining a self-propagating high-temperature synthesis (SHS) reaction. At least a portion of the powder feedstock is additively manufactured into a preformed shape approximating a desired shape of the component. The preformed shape is filled with the HEA powder feedstock. The powdered HEA precursor in the preformed shape are ignited to induce the self-propagating high-temperature synthesis (SHS) reaction, thereby forming a stable HEA component approximating the desired shape.

An example embodiment of a method is disclosed for making a component including a high entropy alloy (HEA). The method includes identifying a desired shape of the component and producing a shell or a mold having an interior volume corresponding to the desired shape of the component via at least one additive manufacturing process. A reaction component is added to the interior volume of the shell or the mold and combined with the powdered HEA precursor. The reaction component is configured to facilitate a self-propagating high-temperature synthesis (SHS) reaction with the powdered HEA precursor. The combined powdered HEA precursor and the SHS component are ignited in the shell or mold, thereby forming a stable HEA component approximating the desired shape of the component. The stable HEA component is removed from the shell or the mold.

### BRIEF DESCRIPTION OF THE DRAWINGS

FIG. 1 is a first flow chart illustrating a first non-limiting example embodiment of the method.

FIG. 2 is a second flow chart illustrating a second non-limiting example embodiment of the method.

### DETAILED DESCRIPTION

Generally speaking, the disclosure combines Additive Manufacturing (AM) and Self-propagating high temperature synthesis (SHS), or its derivative processes for the production of HEAs in complex shapes. First, we create a cake using precursor HEA and SHS process. The cake can be ground and the resulting powder can be further spheroidized and used for printing 3D objects. Alternatively, thoroughly blended fine HEA powders can be placed inside a 3D printed capsule. The powder is then ignited and a combustion wave propagates through the blended powder fully consolidating the material.

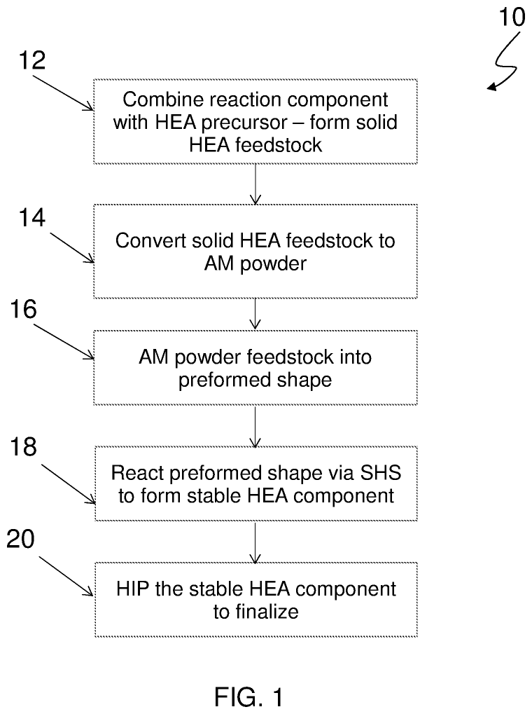

FIG. 1 shows example method 10, steps for making a component comprising a high entropy alloy (HEA). As noted above, high entropy alloys are an emerging class of materials. Due to their nature, it is difficult to identify promising candidate compositions which exhibit excellent physical properties often exceeding those of conventional alloys and even many superalloys. It is even more difficult, once formed, to process these materials into useful shapes as conventional mechanical processing techniques destabilize the delicate balance of the nanophases metastable grain boundaries, and atomic-level interactions that make the materials possible in the first place.

Method 10 includes step 12 of combining a reaction component with a powdered HEA precursor to form a solid HEA feedstock. Common examples of HEA precursors take many forms but in most cases involve a combination of 4 or more compatible metal elements that will eventually react to form the final HEA component in to something approximating or equivalent to desired shape. The HEA elements themselves may be reactive, but perhaps not enough to facilitate an SHS reaction, therefore, additional reaction component(s) can be added to facilitate the reaction of the elements in the powdered HEA precursor. Examples are based on the particular selection of HEA chemistry but common reaction components can include nickel, aluminum, titanium, cobalt, chromium, iron, manganese, molybdenum, niobium, tantalum, tungsten, zirconium and vanadium, but many other combinations of elements can be considered, including refractory metals and ceramics.

Though it can be called a “cake” or “puck”, the solid HEA feedstock can actually take any common form suitable for step 14, which is to convert the solid HEA feedstock into a powder suitable for use as a powder feedstock in an additive manufacturing device. Here, processing includes, but is not limited to grinding, rolling, and/or spheroidizing.

Once in suitable form, step 16 includes additively manufacturing at least a portion of the powder feedstock into a preformed shape approximating a desired shape of the component. As is known, AM processes can vary somewhat widely, particularly based on the composition of the powder and the parameters selected.

As part of, or subsequent to step 16, step 18 is to react or ignite the powdered HEA precursor and the reaction component in the preformed shape to induce a self-propagating high-temperature synthesis (SHS) reaction, which propagates throughout the entire preform to produce a dense bonded structure, thereby forming a stable HEA component approximating the desired shape as described above. The reaction can take many forms but in this free-form embodiment, sufficient heat and pressure are generated to further consolidate the freeform powder preformed shape once the reaction is initiated.

Some stable HEA components include at least a combination of niobium, molybdenum, tantalum, and tungsten. In certain embodiments, the stable HEA component further includes vanadium. In certain embodiments, each are present in approximately equivalent molar percentages. In certain embodiments, each element can be present in any molar percentage. Small variations up to +/−2 mol % for one or more elements, due to process tolerances and/or optimization of certain microstructures may occur.

Other example stable HEA components can include at least a combination of aluminum, titanium, zirconium, niobium, molybdenum, and tantalum. In certain embodiments, the aluminum, titanium, zirconium, niobium, each have a first molar percentage, and the molybdenum and tantalum each have a second molar percentage. Each first molar percentage is approximately equivalent, and each second molar percentage is approximately half of each of the first molar percentage. In other words the molar percentages of molybdenum and tantalum add up to the first molar percentage.

Optionally, the stable HEA component only approximates the desired shape, porosity, or other properties and can only be subjected to limited post-processing that will not unduly disturb the delicate balance of atomic-level interactions. One allowable step is performing a hot isostatic processing (HIP) step 20 on at least the stable HEA component to finalize the stable HEA component into the desired shape. To facilitate one or more HIP steps 20, the stable HEA component can be placed in a mold which may itself be additively manufactured.

As noted, it has been extremely difficult and/or unreliable to produce complex shapes from HEA alloys as they are not amenable to conventional post-processing or even conventional additive manufacturing. Sometimes the freeform approach described relative to FIG. 1 is not entirely suitable or reliable due to the desired component shape being sufficiently complex.

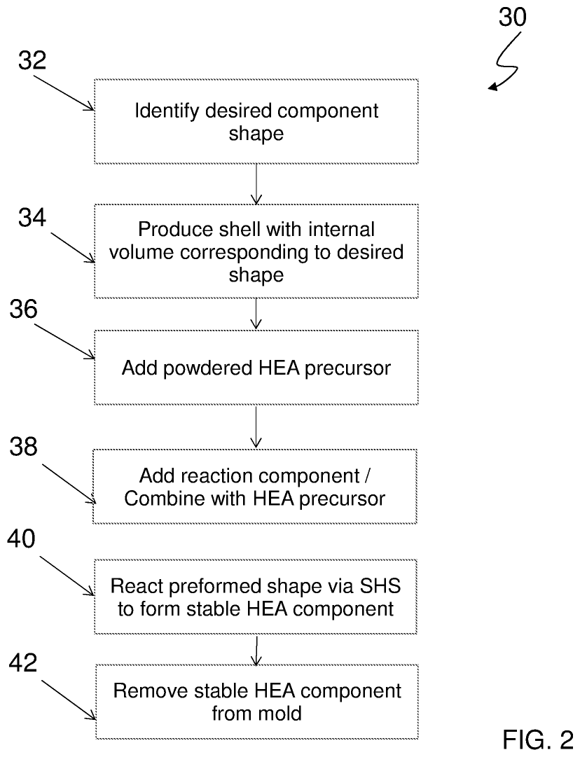

Thus moving to FIG. 2, method 30 for making a component with a HEA includes step 32 of identifying a desired shape of the component. Step 34 then includes producing a shell or a mold having an interior volume corresponding to the desired shape of the component via at least one additive manufacturing process. This corresponding interior shape can be an approximation or a precise negative of the desired component shape.

For step 36, a powdered HEA precursor is added to the interior volume of the shell or the mold, and around an internal core if needed, before, during or after which, a reaction component is added with the powdered HEA precursor (step 38) to form a preformed shape. This reaction component is configured to facilitate a self-propagating high-temperature synthesis (SHS) reaction with the powdered HEA precursor of step 36. Examples of these materials are generally similar to those described relative to FIG. 1.

Once combined, step 40 includes reacting the combined powdered HEA precursor and the SHS component in the shell or mold, and internal core if needed, thereby forming a stable HEA component from the preformed shape. The mold or shell helps retain the contours of the preformed shape during and immediately after the reaction so that the stable HEA component at least approximates the desired shape of the component when complete, until it can be removed from the shell or the mold (step 42). Any residual shell or mold, or internal core if present, can be removed by any of a variety of processes including burn-out, acid or caustic leaching.

Similar to the freeform approach, method 30 can also include optionally performing a hot isostatic processing (HIP) step on at least the stable HEA component. The HIP step can be performed prior to and/or after the removing step.

The resulting stable HEA component can have similar or identical compositions to those described relative to example method 10/FIG. 1. In this case, however, the more ability to produce and maintain more complex shapes out of the shells and molds would make the process suitable for gas turbine or other very high temperature components. This is especially true as some HEA materials have been shown to have high temperature mechanical properties that can exceed those of superalloys currently in use. Thus the ability to form more complex shapes is likely to allow for parts such as combustor liner or a turbine airfoil for a gas turbine engine to be reliably made with HEA materials.

Further, internal cooling of these and other parts can likely be incorporated, for example by forming an internal core around which the combined powdered HEA precursor and the SHS component are placed prior to the reacting step. After removing the core from the stable HEA component, it defines at least one internal cooling passage therein.

### Discussion of Possible Embodiments

The following are non-exclusive descriptions of possible embodiments of the present disclosure.

An example embodiment of a method is disclosed for making a component including a high entropy alloy (HEA). The method includes combining a reaction component with a powdered HEA precursor to form a solid HEA feedstock. The solid HEA feedstock is converted into a powder suitable for use as a powder feedstock in an additive manufacturing device and capable of sustaining a self-propagating high-temperature synthesis (SHS) reaction. At least a portion of the powder feedstock is additively manufactured into a preformed shape approximating a desired shape of the component. The preformed shape is filled with the HEA powder feedstock. The powdered HEA precursor in the preformed shape are ignited to induce the self-propagating high-temperature synthesis (SHS) reaction, thereby forming a stable HEA component approximating the desired shape.

The method of the preceding paragraph can optionally include, additionally and/or alternatively, any one or more of the following features, configurations and/or additional components: An embodiment of a method for making a component comprising a high entropy alloy (HEA), the method comprising: combining a reaction component with a powdered HEA precursor to form a solid HEA feedstock; converting the solid HEA feedstock into a powder suitable capable of sustaining a self-propagating high-temperature synthesis (SHS) reaction for use as a powder feedstock in an additive manufacturing device; additively manufacturing at least a portion of the powder feedstock into a preformed shape approximating a desired shape of the component; filling the preformed shape with the HEA powder feedstock; and igniting the powdered HEA precursor in the preformed shape to induce a self-propagating high-temperature synthesis (SHS) reaction, thereby forming a stable HEA component approximating the desired shape.

A further embodiment of the foregoing method, further comprising: performing a hot isostatic processing (HIP) step on at least the stable HEA component to finalize the stable HEA component into the desired shape.

A further embodiment of any of the foregoing methods, wherein the HIP step is performed in a mold after the reacting step.

A further embodiment of any of the foregoing methods, wherein the mold is additively manufactured to match the desired shape.

A further embodiment of any of the foregoing methods, wherein the stable HEA component comprises niobium, molybdenum, tantalum, and tungsten each in up to equivalent molar percentages.

A further embodiment of any of the foregoing methods, wherein the stable HEA component further comprises vanadium also in up to equivalent molar percentages of niobium, molybdenum, tantalum, and tungsten.

A further embodiment of any of the foregoing methods, wherein the stable HEA component comprises nickel, cobalt, chromium, iron, aluminum, titanium, zirconium, niobium, molybdenum, and tantalum up to equivalent molar percentages.

A further embodiment of any of the foregoing methods, wherein the aluminum, titanium, zirconium, niobium, each have a first molar percentage, and the molybdenum and tantalum each have a second molar percentage, wherein each first molar percentage is approximately equivalent, and wherein each second molar percentage is approximately half of each of the first molar percentage.

A further embodiment of any of the foregoing methods, wherein the filling step includes the HEA powder feedstock and an additional reaction component, and the igniting step also includes igniting the additional reaction component.

An example embodiment of a method is disclosed for making a component including a high entropy alloy (HEA). The method includes identifying a desired shape of the component and producing a shell or a mold having an interior volume corresponding to the desired shape of the component via at least one additive manufacturing process. A reaction component is added to the interior volume of the shell or the mold and combined with the powdered HEA precursor. The reaction component is configured to facilitate a self-propagating high-temperature synthesis (SHS) reaction with the powdered HEA precursor. The combined powdered HEA precursor and the SHS component are ignited in the shell or mold, thereby forming a stable HEA component approximating the desired shape of the component. The stable HEA component is removed from the shell or the mold.

The method of the preceding paragraph can optionally include, additionally and/or alternatively, any one or more of the following features, configurations and/or additional components: identifying a desired shape of the component; An embodiment of a method for making a component comprising a high entropy alloy (HEA), the method comprising: producing a shell or a mold having an interior volume corresponding to the desired shape of the component via at least one additive manufacturing process; adding a powdered HEA precursor to the interior volume of the shell or the mold; combining a reaction component with the powdered HEA precursor, the reaction component configured to facilitate a self-propagating high-temperature synthesis (SHS) reaction with the powdered HEA precursor; and igniting the combined powdered HEA precursor with the reaction component to initiate a SHS reaction in the powder contained by the shell or mold, thereby forming a stable HEA component approximating the desired shape of the component; and removing the stable HEA component from the shell or the mold.

A further embodiment of the foregoing method, further comprising: performing a hot isostatic processing (HIP) step on at least the stable HEA component.

A further embodiment of any of the foregoing methods, wherein the HIP step is performed prior to the removing step.

A further embodiment of any of the foregoing methods, wherein the HIP step is performed after the removing step.

A further embodiment of any of the foregoing methods, wherein the stable HEA component comprises niobium, molybdenum, tantalum, and tungsten each in approximately equivalent molar percentages.

A further embodiment of any of the foregoing methods, wherein the stable HEA component further comprises vanadium also in an approximately equivalent molar percentage to the molar percentages of niobium, molybdenum, tantalum, and tungsten.

A further embodiment of any of the foregoing methods, wherein the stable HEA component comprises aluminum, titanium, zirconium, niobium, molybdenum, and tantalum.

A further embodiment of any of the foregoing methods, wherein the aluminum, titanium, zirconium, niobium, each have a first molar percentage, and the molybdenum and tantalum each have a second molar percentage, wherein each first molar percentage is approximately equivalent, and wherein each second molar percentage is approximately half of each of the first molar percentage.

A further embodiment of any of the foregoing methods, wherein the desired shape of the component includes a combustor liner or a turbine airfoil for a gas turbine engine.

A further embodiment of any of the foregoing methods, further comprising forming a core around which the combined powdered HEA precursor and the SHS component are placed prior to the reacting step.

A further embodiment of any of the foregoing methods, further comprising removing the core from the stable HEA component, thereby defining at least one internal passage therein.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method for making a component comprising a high entropy alloy (HEA), the method comprising:
combining a reaction component with a powdered HEA precursor to form a solid HEA feedstock;
convert the solid HEA feedstock into a powder suitable capable of sustaining a self-propagating high-temperature synthesis (SHS) reaction for use as a powder feedstock in an additive manufacturing device;
additively manufacturing at least a portion of the powder feedstock into a preformed shape approximating a desired shape of the component;
filling the preformed shape with the HEA powder feedstock; and
igniting the powdered HEA precursor in the preformed shape to induce a self-propagating high-temperature synthesis (SHS) reaction, thereby forming a stable HEA component approximating the desired shape.

2. The method of claim 1, further comprising:
performing a hot isostatic processing (HIP) step on at least the stable HEA component to finalize the stable HEA component into the desired shape.

3. The method of claim 2, wherein the HIP step is performed in a mold after the reacting step.

4. The method of claim 3, wherein the mold is additively manufactured to match the desired shape

5. The method of claim 1, wherein the stable HEA component comprises niobium, molybdenum, tantalum, and tungsten each in up to equivalent molar percentages.

6. The method of claim 5, wherein the stable HEA component further comprises vanadium also in up to equivalent molar percentages of niobium, molybdenum, tantalum, and tungsten.

7. The method of claim 1, wherein the stable HEA component comprises nickel, cobalt, chromium, iron, aluminum, titanium, zirconium, niobium, molybdenum, and tantalum up to equivalent molar percentages.

8. The method of claim 1, wherein the aluminum, titanium, zirconium, niobium, each have a first molar percentage, and the molybdenum and tantalum each have a second molar percentage, wherein each first molar percentage is approximately equivalent, and wherein each second molar percentage is approximately half of each of the first molar percentage.

9. The method of claim 1, wherein the filling step includes the HEA powder feedstock and an additional reaction component, and the igniting step also includes igniting the additional reaction component.

10. A method for making a component comprising a high entropy alloy (HEA), the method comprising:
identifying a desired shape of the component;
producing a shell or a mold having an interior volume corresponding to the desired shape of the component via at least one additive manufacturing process;
adding a powdered HEA precursor to the interior volume of the shell or the mold;
combining a reaction component with the powdered HEA precursor, the reaction component configured to facilitate a self-propagating high-temperature synthesis (SHS) reaction with the powdered HEA precursor; and
igniting the combined powdered HEA precursor with the reaction component to initiate a SHS reaction in the powder contained by the shell or mold, thereby forming a stable HEA component approximating the desired shape of the component;
removing the stable HEA component from the shell or the mold.

11. The method of claim 10, further comprising:
performing a hot isostatic processing (HIP) step on at least the stable HEA component.

12. The method of claim 10, wherein the HIP step is performed prior to the removing step.

13. The method of claim 10, wherein the HIP step is performed after the removing step.

14. The method of claim 10, wherein the stable HEA component comprises niobium, molybdenum, tantalum, and tungsten each in approximately equivalent molar percentages.

15. The method of claim 14, wherein the stable HEA component further comprises vanadium also in an approximately equivalent molar percentage to the molar percentages of niobium, molybdenum, tantalum, and tungsten.

16. The method of claim 10, wherein the stable HEA component comprises aluminum, titanium, zirconium, niobium, molybdenum, and tantalum.

17. The method of claim 10, wherein the aluminum, titanium, zirconium, niobium, each have a first molar percentage, and the molybdenum and tantalum each have a second molar percentage, wherein each first molar percentage is approximately equivalent, and wherein each second molar percentage is approximately half of each of the first molar percentage.

18. The method of claim 10, wherein the desired shape of the component includes a combustor liner or a turbine airfoil for a gas turbine engine.

19. The method of claim 10, further comprising forming a core around which the combined powdered HEA precursor and the SHS component are placed prior to the reacting step.

20. The method of claim 19, further comprising removing the core from the stable HEA component, thereby defining at least one internal passage therein.
